(19) United States
(12) Patent Application Publication
(10) Pub. No.: US 2007/0133118 A1
(43) Pub. Date: Jun. 14, 2007

(54) Information storage apparatus

(75) Inventor: Osamu Kajitani, Yokohama (JP)

Correspondence Address: Patrick G. Burns;GREEN, BURNS & CRAIN, LTD., Suite 2500, 300 South Wacker Drive, Chicago, IL, 60606, US

(73) Assignee: FUJITSU LIMITED

(21) Appl. No.: 11/384,840

(22) Filed: Mar. 20, 2006

(30) Foreign Application Priority Data
Dec. 13, 2005 (JP) 2005-359171

(51) Int. Cl. G11B 21/02; G11B 27/36; G11B 5/02

(52) U.S. Cl. 360/75; 360/31; 360/25

(57) ABSTRACT

An information storage apparatus includes a magnetic head having a magnetic pole end that is controllable so as to project, a recording medium for recording and/or reproducing data, a protrusion provided on a surface of the recording medium, the protrusion being used for measuring a flying height of the magnetic head, and a flying-height adjustment controller that adjusts the flying height of the magnetic head by controlling the amount of projection of the magnetic pole end of the magnetic head on the basis of the amount of projection obtained when the magnetic pole end of the magnetic head comes into contact with the protrusion.

### BACKGROUND OF THE INVENTION

1. Field of the Invention

The present invention relates to an information storage apparatus that includes a magnetic head having a thin-film magnetic head element and a high-density recording medium and that records and/or reproduces data using the magnetic head.

2. Description of the Related Art

Recently, there have been demands for small information storage apparatuses with large storage capacities, and magnetic heads having thin-film magnetic head elements that are small and capable of recording and/or reproducing data on recording media with high density have been used to satisfy such a demand. Such a magnetic head is mainly of a combined type including a recording element and a magnetoresistive (MR) element.

FIG. 10 is an enlarged sectional view illustrating a part of a known thin-film magnetic head element. Referring to FIG. 10, a thin-film magnetic head element 10 includes an MR element 17 that forms a reproducing element, a lower magnetic pole layer 12, a coil 14 insulated by an organic insulating layer 13, an upper magnetic pole layer 15, and a protection layer 16 that are successively formed on a substrate 11 by a film-forming process such as CVD, plating, and sputtering.

Typically, the upper magnetic pole layer 15, the lower magnetic pole layer 12, a gap 18 between the magnetic pole layers, and the coil 14 form a recording element and a magnetic field is generated by applying a current to the coil 14. The magnetic field leaks through the gap 18 to magnetize the surface of a recording medium, and data is recorded accordingly.

To increase the storage capacity using the above-described magnetic head, it is necessary to increase the amount of data that can be stored per unit area of the recording medium (recording density). The recording density can be increased by improving the performances of the recording element and the recording medium and increasing the frequency of a recording circuit.

More specifically, the recording density can be increased by, for example, reducing a gap interval in the magnetic head. When the gap interval is reduced, the recording area per bit of data is also reduced. As a result, the number of bits along a single track of the recording medium is increased and a larger amount of data can be recorded.

The recording density can also be increased by increasing the number of tracks that can be recorded on the recording medium. Normally, the number of tracks that can be recorded on a recording medium is expressed in tracks per inch (TPI), and the TPI of the recording element can be increased by reducing the head size (gap width) that determines the track width.

However, when the recording area per bit of data is reduced to increase the recording density as described above, the strength of the magnetic field for recording the data is reduced as the gap interval and/or the gap width of the magnetic head is reduced. Therefore, although the storage capacity can be increased, the reliability of recording and reproducing the data is reduced (recording and reproducing characteristics are degraded).

Accordingly, in order to maintain a sufficient magnetic field strength applied to the recording surface of the recording medium even when the gap interval and/or the gap width of the magnetic head is reduced, techniques for reducing a distance from an end of the recording element and/or the reproducing element (magnetic pole end) to the recording surface of the recording medium, that is, a flying height of the magnetic head, have been suggested.

Japanese Unexamined Patent Application Publication No. 5-020635 discloses a technique for reducing the distance between the magnetic pole end and the recording medium surface (flying height of the magnetic head) by applying a current to a thin-film resistor disposed in the thin-film magnetic head element so that the thin-film resistor generates heat that causes the magnetic pole end to thermally expand and project.

More specifically, first, a current is applied to the thin-film resistor that is disposed in the thin-film magnetic head element included in the magnetic head. Accordingly, the thin-film resistor generates heat that causes the magnetic pole end to project. Then, the contact vibration between the projected magnetic pole end and the recording medium surface is detected by an acoustic emission (AE) sensor. When the detection output is larger than a reference value, the current applied to the thin-film resistor in the thin-film magnetic head element is stopped to reduce the heat generated, thereby reducing the amount of projection of the magnetic pole end. When the detection output is smaller than the reference value, a reproduction output obtained from the recording medium is checked. When the reproduction output is larger than a reference value, the current applied to the thin-film resistor in the thin-film magnetic head element is stopped to reduce the heat generated, thereby reducing the amount of projection of the magnetic pole end. When the reproduction output is smaller than the reference value, the current applied to the thin-film resistor in the thin-film magnetic head element is increased to increase the heat generated, thereby increasing the amount of projection of the magnetic pole end. The above-described steps are repeated to adjust the current applied to the thin-film resistor during the recording or reproducing operation of the magnetic head. Accordingly, the amount of projection of the magnetic pole end is controlled such that the distance between the magnetic pole end and the recording medium surface is maintained at an optimum distance. Therefore, the risk of head crash can be eliminated and high-reliability, high-density data recording and/or reproducing can always be performed.

On the other hand, small information storage apparatuses with large storage capacities are often used as portable information apparatuses (mobile apparatuses) like notebook computers. Although mobile apparatuses are useful in that they can be carried and used at different locations or while moving, there are disadvantages in that they are easily influenced by the operating environment, such as air pressure and temperature variation, and stable activation cannot be ensured. For example, the flying height of the magnetic head tends to be reduced when the air pressure is low or the temperature is high. Thus, the variation in the operating environment exerts a serious influence on the stability of the flying height of the magnetic head (causes variation in the flying height).

In order to exploit the advantages of the mobile apparatuses that they can be carried and used in different locations or while moving, the mobile apparatuses are designed on the assumption that they may be used in an environment where the air pressure and temperature will greatly vary (for example, in an airplane or at high or low latitude).

In a known structure, each time the mobile apparatus is turned on, the magnetic pole end is caused to project until the magnetic pole end comes into contact with the recording medium surface. Then, the amount of projection of the magnetic pole end is controlled so as to set the flying height of the magnetic head as small as possible by repeating the adjustment. Thus, the variation in the flying height of the magnetic head due to the variation in the air pressure or temperature in the operating environment of the mobile apparatus is reduced.

However, such a mobile apparatus is required not only to reduce the flying height of the magnetic head as described above but also to increase battery life (to reduce power consumption) as a basic requirement. If the operation for adjusting the flying height of the magnetic head at the optimum flying height for data recording and/or reproducing (flying height calibration) is repeated each time the apparatus is turned on, the variation in the flying height due to the variation in the air pressure or temperature can be reduced. However, battery life is reduced since a considerably long time and large power consumption are required for the calibration for the calibration.

The flying height of the magnetic head is set for each product model before shipment. However, in practice, the flying height differs for each product due to differences in component accuracy and assembly accuracy between the products. The differences in the flying height due to differences in component accuracy and assembly accuracy between the products are not limited to the mobile apparatuses but occur in all apparatuses.

The problem of the differences in the flying height can also be solved by repeating the flying height calibration each time the apparatus is turned on and adjusting the flying height of the magnetic head for each product. However, as described above, there are problems that it takes a long time to activate the apparatus since a relatively long time is required for the calibration and a large amount of power is consumed.

To prevent this, the flying height of the magnetic head may also be calibrated by determining the flying height of the magnetic head on the basis of the amount of projection obtained when the magnetic pole end comes into contact with the surface of the recording medium and controlling the amount of projection of the magnetic pole end such that the flying height of the magnetic head is adjusted to a desired flying height. However, since the surface of the recording medium generally has grooves (texture) for preventing the magnetic head from adhering thereto and the measurement of the flying height is influenced by the roughness of the texture, the reliability of the measurement of the flying height is low and it is difficult to obtain the accurate flying height. On the other hand, as the storage capacity of the recording medium is increased, the fineness of the texture and the surface smoothness of the recording medium are increased. Accordingly, particularly in recent years when there have been increasing demands for large capacity recording media, a risk that the magnetic head will adhere to the surface of the recording medium has been increased.

Therefore, it is extremely difficult to cause the magnetic pole end of the magnetic head to come into contact with the surface of the recording medium and determine the accurate flying height of the magnetic head on the basis of the amount of projection of the magnetic pole end at that time.

In the known structure, since the flying height of the magnetic head tends to be reduced when the air pressure is low or the temperature is high, the flying height is generally set to be relatively large in order to prevent the magnetic head from coming into contact with the surface of the recording medium when the magnetic head is loaded to a position above the recording medium. On the contrary, since the flying height of the magnetic head tends to be increased when the air pressure is high or the temperature is low, there is a possibility that the flying height of the magnetic head may be too large when the magnetic head is loaded to the position above the recording medium.

When the flying height of the magnetic head is large, the magnetic pole end, of course, must be projected by a large amount and the calibration takes a long time. In addition, there is a risk that the magnetic pole end cannot project long enough to come into contact with the recording medium surface. In addition, if the magnetic pole end is projected by a very large amount, there is a risk that the projecting portion will deform plastically and the magnetic pole end cannot return to the initial position even when the heater is turned off.

### SUMMARY OF THE INVENTION

In view of the above-described situation, an object of the present invention is to provide a power-saving information storage apparatus that can quickly perform calibration and be activated in a short time by determining the accurate flying height of a magnetic head.

In addition, another object of the present invention is to provide an information storage apparatus including a magnetic head with high durability that prevents plastic deformation of a magnetic pole end by preventing the magnetic pole end from projecting by a large amount.

An information storage apparatus according to the present invention includes a magnetic head having a magnetic pole end that is controllable so as to project; a recording medium for recording and/or reproducing data; a protrusion provided on a surface of the recording medium, the protrusion being used for measuring a flying height of the magnetic head; and a flying-height adjustment controller that adjusts the flying height of the magnetic head by controlling the amount of projection of the magnetic pole end of the magnetic head on the basis of the amount of projection obtained when the magnetic pole end of the magnetic head comes into contact with the protrusion.

In addition, unlike the known structure, it is not necessary to cause the magnetic pole end to project to the surface of the recording medium and the distance by which the magnetic pole end is caused to project is reduced, which also reduces the time required for calibration. In addition, even when the flying height of the magnetic head is very large, plastic deformation of the magnetic pole end is prevented since the magnetic pole end is prevented from projecting by a large amount.

In addition, since the magnetic pole end does not come into direct contact with the surface of the recording medium, the magnetic head is prevented from adhering to the surface of the recording medium.

According to the present invention, since a protrusion (bump) having a predetermined height and used for measuring the flying height is formed in a region outside the data zone of the recording medium and the projection of the magnetic pole end is caused to come into contact with the bump in the calibration process, the accurate flying height can be measured. Accordingly, the time required for calibration can be reduced and a power saving information storage apparatus that can be activated in a short time can be provided.

In addition, according to the present invention, since a protrusion (bump) having a predetermined height and used for measuring the flying height is formed in a region outside the data zone of the recording medium and the projection of the magnetic pole end is caused to come into contact with the bump in the calibration process, the magnetic pole end is prevented from projecting by a large amount even when the flying height of the magnetic head is large. Accordingly, plastic deformation of the magnetic pole end is prevented and an information storage apparatus having a magnetic head with high durability can be provided.

### BRIEF DESCRIPTION OF THE DRAWINGS

FIG. 1A is a side view of a magnetic head according to the present invention and FIG. 1B is an enlarged sectional view of a thin-film magnetic head element according to the present invention;

FIG. 2 is a graph showing the relationship between the amount of projection of a magnetic pole end and the electric power applied to a heating device;

FIG. 3 is a partial perspective view of an information storage apparatus according to the present invention.

FIG. 4 is a control block diagram of the information storage apparatus according to the present invention;

FIG. 5 is a diagram illustrating a bump formed on a recording medium included in the information storage apparatus according to the present invention;

FIG. 6 is a diagram illustrating a method for forming the bump on the recording medium included in the information storage apparatus according to the present invention;

FIG. 7 is a flowchart illustrating a process for calibrating a magnetic head flying height according to a first embodiment of the present invention;

FIGS. 8A to 8C are diagrams illustrating the steps of the process for calibrating the magnetic head flying height according to the present invention;

FIG. 9 is a flowchart illustrating a process for calibrating a magnetic head flying height according to a second embodiment of the present invention;

FIG. 10 is an enlarged sectional view illustrating a part of a known thin-film magnetic head element.

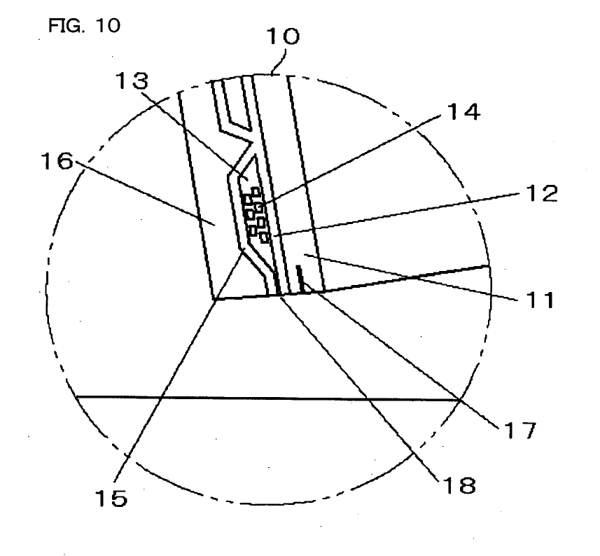

### DESCRIPTION OF THE PREFERRED EMBODIMENTS

Embodiments of the present invention will be described below with reference to the accompanying drawings.

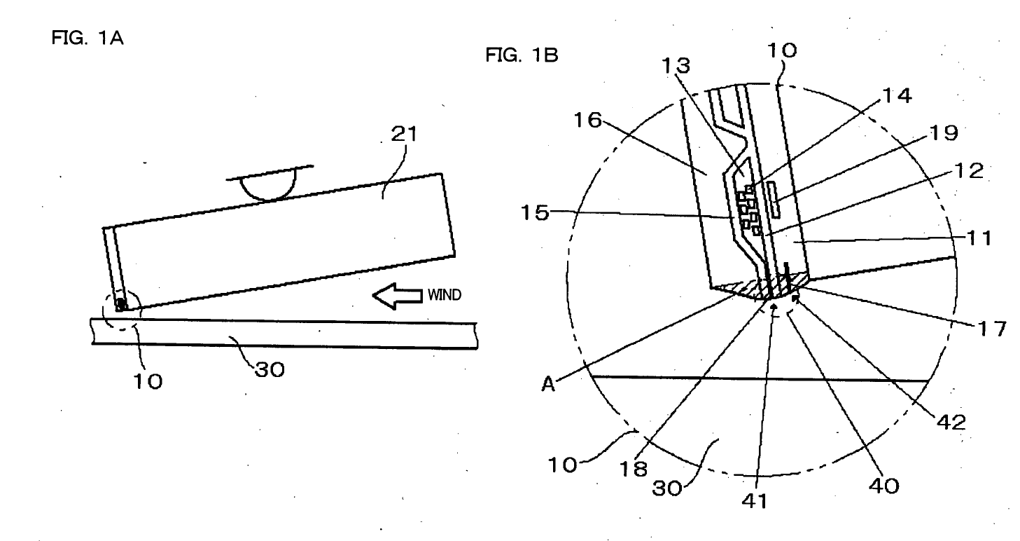

FIG. 1A is a side view of a magnetic head according to the present invention and FIG. 1B is an enlarged sectional view of a thin-film magnetic head element according to the present invention.

Referring to FIG. 1A, a thin-film magnetic head element 10 is provided at an end of a magnetic head 21. When a recording medium 30 rotates, the magnetic head 21 flies above the surface of the recording medium 30 using an airflow generated along the medium surface. Accordingly, the thin-film magnetic head element 10 provided at the end of the magnetic head 21 can record or reproduce data without coming into contact with the surface of the recording medium 30. The flying height of the magnetic head is optimally set equal to or less than about 10 nm.

Referring to FIG. 1B, a substrate 11 is made of alumina-titanium carbide (Al203-TiC). An MR element 17 that forms a reproducing element 42, a heating device 19 including a thin-film resistor made of tungsten or the like, a lower magnetic pole layer 12, a coil 14 insulated by an organic insulating layer 13, an upper magnetic pole layer 15, and a protection layer 16 made of alumina or the like are successively formed on the substrate 11 by a film-forming process such as CVD, plating, and sputtering.

The reproducing element 42 is formed of the MR element 17 having a resistance that varies proportionally with the strength of the magnetic field. The MR element 17 is placed in a nonmagnetic pole layer. A weak magnetic field on the recording medium surface is sensed and converted into a voltage due to a magnetoresistance effect, and data is reproduced accordingly. An anisotropic magnetic resistance (AMR) element, a giant magnetic resistance (GMR) element, a tunneling magnetic resistance (TMR) element that causes the MR effect using a tunneling current, etc., are commonly known as MR elements.

A recording element 41 is an inductive electromagnetic transducer that is laminated on the reproducing element 42. The thin-film inductive electromagnetic transducer that functions as the recording element 41 has the lower magnetic pole layer 12, a gap 18, the upper magnetic pole layer 15, and the coil 14 supported by the insulating layer 13. End portions of the lower magnetic pole layer 12 and the upper magnetic pole layer 15 face each other across the small gap 18 and data is record by a magnetic field generated in the gap 18. The lower magnetic pole layer 12 and the upper magnetic pole layer 15 are coupled to each other on the side opposite to the side facing the recording medium so as to form a magnetic circuit. The heating device 19 is disposed near the recording element 41 and the reproducing element 42 and generates heat when the electric power is applied so that the thin-film magnetic head element 10 is heated and a magnetic pole end 40 of the recording and reproducing elements 41 and 42 projects as shown by A. The magnetic pole end 40 projects as shown by A because the coefficients of thermal expansion of the organic insulating layer 13, the lower magnetic pole layer 12, the upper magnetic pole layer 15, and the MR element 17 are higher than those of the substrate 11 and the protection layer 16.

In the present embodiment, the end of the recording element 41 and the end of the reproducing element 42 project together and the magnetic pole end 40 is projected for recording or for reproducing is controlled by software.

According to the present embodiment, a single heating device 19 is disposed in the thin-film magnetic head element 10 and is used for causing the projection for both recording and reproducing. However, in other embodiments, a heating device for the recording element and a heating device for the reproducing element may be provided individually and be used for the respective purposes.

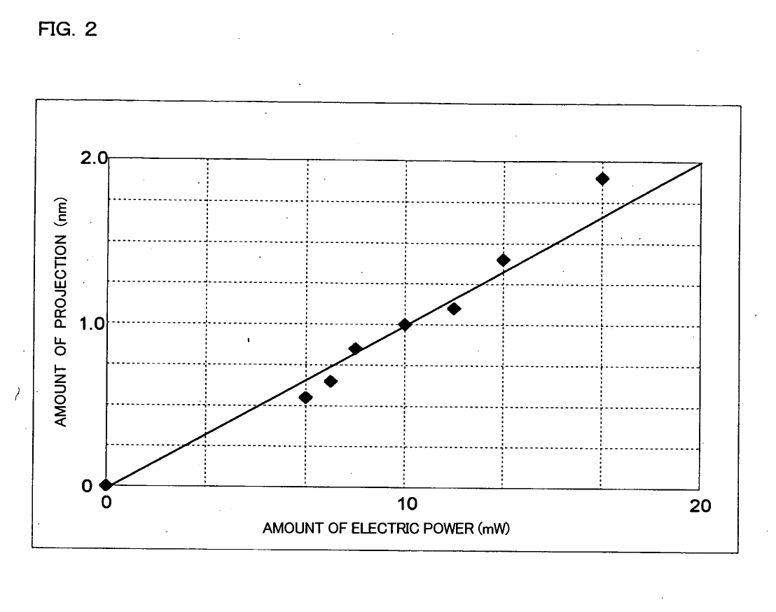

FIG. 2 is a graph showing the relationship between the amount of projection of the magnetic pole end and the electric power applied to the heating device. In FIG. 2, the vertical axis shows the amount of projection (nm) of the magnetic pole end and the horizontal axis shows the electric power (mW) applied to the heating device. The amount of projection of the magnetic pole end is substantially proportional to the electric power applied the heating device. For example, the magnetic pole end can be projected by 1.0 nm with an electric power of 10 mW, and by 2.0 nm with an electric power of 20 mW.

Accordingly, by adjusting the electric power applied to the heating device 19 on the basis of the relationship between the amount of projection of the magnetic pole end 40 and the electric power applied the heating device 19, the magnetic pole end 40 can be controlled so as to project by a desired amount. Thus, the flying height of the magnetic head can be adjusted to an optimum flying height and high-reliability, high-density data recording and/or reproducing can always be performed.

The above-described technique for controlling the flying height of the magnetic head by causing the magnetic pole end to project allows fine flying-height adjustment that is difficult to achieve by the apparatus design in information storage apparatuses that are required to set the flying height with high precision. Thus, this technique is particularly advantageous in that high-reliability, high-density data recording and/or reproducing can always be performed.

Next, an information storage apparatus according to an embodiment of the present invention will be described in detail below.

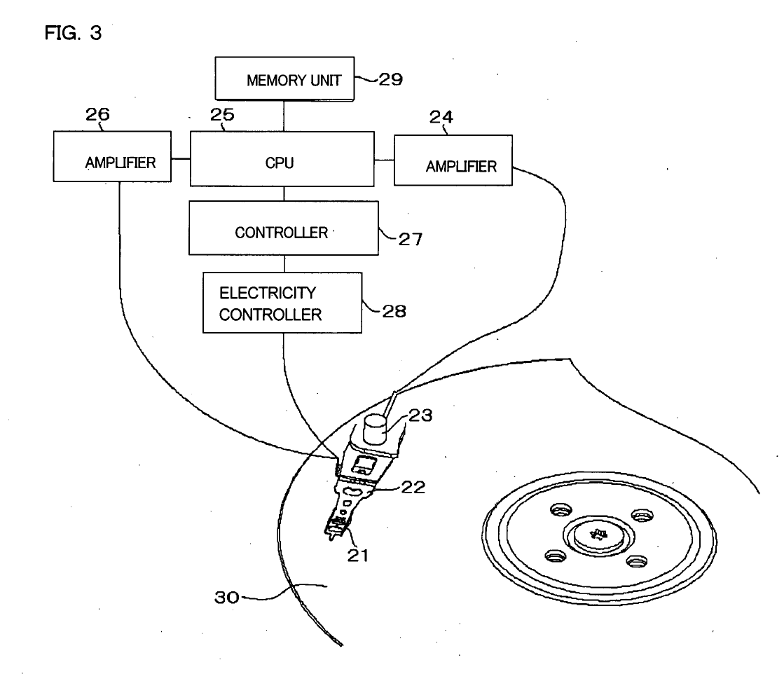

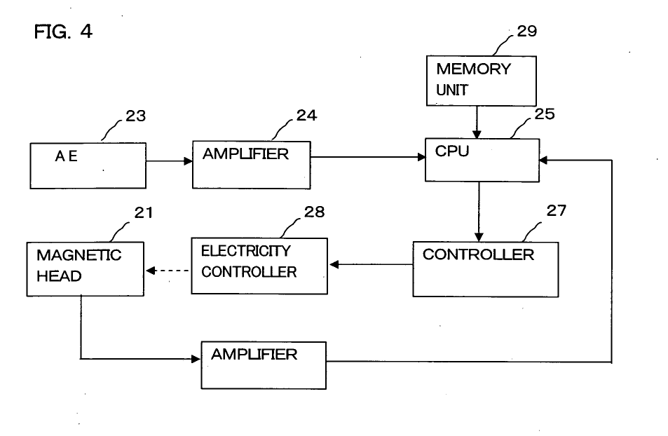

FIG. 3 is a partial perspective view of an information storage apparatus according to the present invention. FIG. 4 is a control block diagram of the information storage apparatus according to the present invention. Referring to FIG. 3, the magnetic head 21 includes the thin-film magnetic head element 10 according to the present invention and is attached to an actuator 22 at an end thereof. An acoustic emission (AE) sensor 23 is attached to the actuator 22 at the other end thereof. The acoustic emission sensor 23 detects contact vibration generated when the magnetic head 21 comes into contact with the surface of the recording medium 30 and outputs a signal.

Referring to FIG. 4, the output signal from the acoustic emission sensor 23 is amplified by an amplifier 24 and is input to a CPU-LSI 25. A reproduction signal obtained by the magnetic head 21 from the recording medium 30 is amplified by an amplifier 26 and is input to a read circuit in the CPU-LSI 25, where the signal is processed. The CPU-LSI 25 includes a CPU having a flying-height adjustment controller. The flying-height adjustment controller reads data representing the relationship between the amount of projection of the magnetic pole end and the electric power applied to the heating device and data representing the desired flying height from a memory unit 29 as necessary. In addition, the flying-height adjustment controller calculates the amount of deformation of the magnetic pole end and the flying height, and outputs a signal designating the electric power to be applied to the heating device 19 to a controller (heating device controller) 27. The controller 27 controls an electricity controller 28 on the basis of the signal obtained from the CPU to adjust the electric power applied to the heating device 19 disposed in the thin-film magnetic head element 10. The memory unit 29 is connected to the CPU-LSI 25, and the CPU can arbitrarily write or read data to/from the memory unit 29. Data written to or read from the memory unit 29 includes the electric power for obtaining the optimum flying height of the magnetic head that is calculated by the CPU and the current flying height of the magnetic head.

Next, a protrusion (bump) formed on the recording medium according to the present embodiment will be described below.

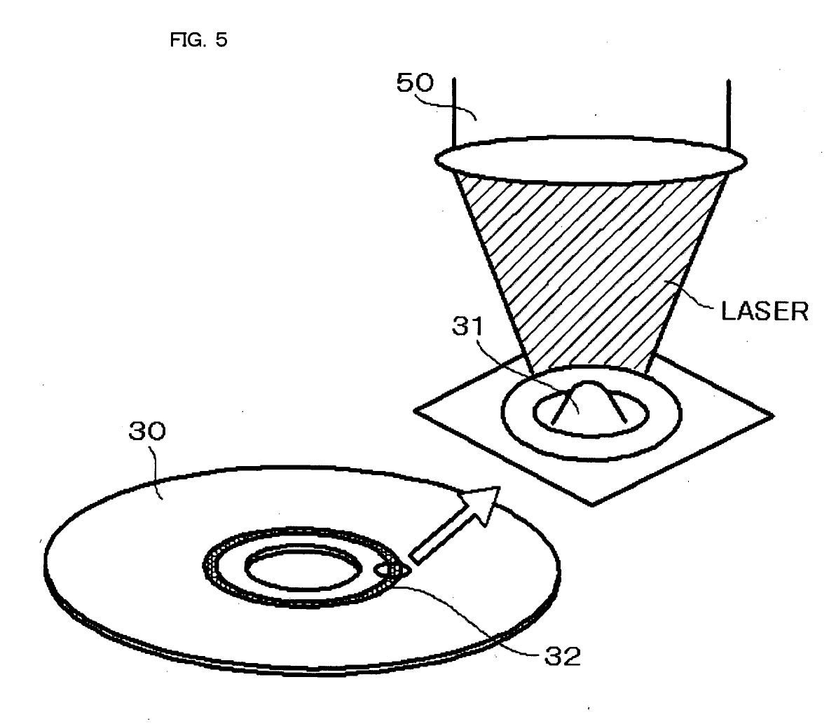

FIG. 5 is a diagram illustrating a bump formed on a recording medium in the information storage apparatus according to the present invention.

Referring to FIG. 5, a bump 31 is formed by a laser texture processing machine 50 in an unused region (region in which user data is not written) 32 outside a data zone of the recording medium 30. Accordingly, a problem that data cannot be recorded on or read from the recording medium 30 because of the bump 31 does not occur and the bump 31 can be formed on the recording medium 30 without reducing the storage capacity thereof.

According to the present invention, the bump 31 is a protrusion used for determining the accurate flying height of the magnetic head in the process of calibrating the flying height. The bump is formed in a shape with high precision in a step performed after texture processing when the medium is manufactured. The bump having a desired height can be precisely formed by laser texture processing.

The CPU has a projection measurement unit that determines the amount of projection corresponding to the electric power applied to the heating device when the magnetic pole end comes into contact with the bump 31 on the basis of the relationship between the amount of projection of the magnetic pole end and the electric power applied to the heating device shown in FIG. 2. Accordingly, the accurate flying height of the magnetic head can be calculated by adding the determined amount of projection and the height of the bump 31.

The height of the bump 31 is set to several nanometers from the surface of the recording medium 30, and it is necessary that the height of the bump 31 be smaller than the desired flying height (10 nm or less). The flying height of the magnetic head is normally desired to be equal to or less than about 10 nm. If the height of the bump 31 is larger than 10 nm, the electric power to be applied to the heating device 19 to set the magnetic head 21 at the desired flying height is higher than that applied when the magnetic pole end comes into contact with the bump 31. Therefore, calibration cannot be performed.

The desired flying height refers to a flying height at which the reproducing element 42 of the magnetic head can receive an optimum reproduction output from the recording medium and/or a flying height at which the recording element 41 of the magnetic head can apply a magnetic field that can write data on the recording medium with high stability. The desired flying height is set for each product model.

Since the bump 31 is formed in the region 32 outside the data zone of the recording medium 30, the accurate flying height of the magnetic head can be obtained and the electric power to be applied to the heating device 19 to set the flying height of the magnetic head to the desired flying height can be accurately determined. Accordingly, the number of times the magnetic pole end is caused to project during calibration can be reduced and the flying height of the magnetic head can be quickly set to the desired flying height. Thus, the time required for calibration can be reduced.

In addition, unlike the known structure, it is not necessary to cause the magnetic pole end to project to the surface of the recording medium since the magnetic pole end comes into contact with the bump 31 when the calibration is performed. Accordingly, the distance by which the magnetic pole end is caused to project during calibration is reduced, which also reduces the time required for calibration. In addition, even when the flying height of the magnetic head is very large, plastic deformation of the magnetic pole end is prevented since the magnetic pole end is prevented from projecting by a large amount.

In addition, since the magnetic pole end does not come into direct contact with the surface of the recording medium, the magnetic head 21 is prevented from adhering to the surface of the recording medium.

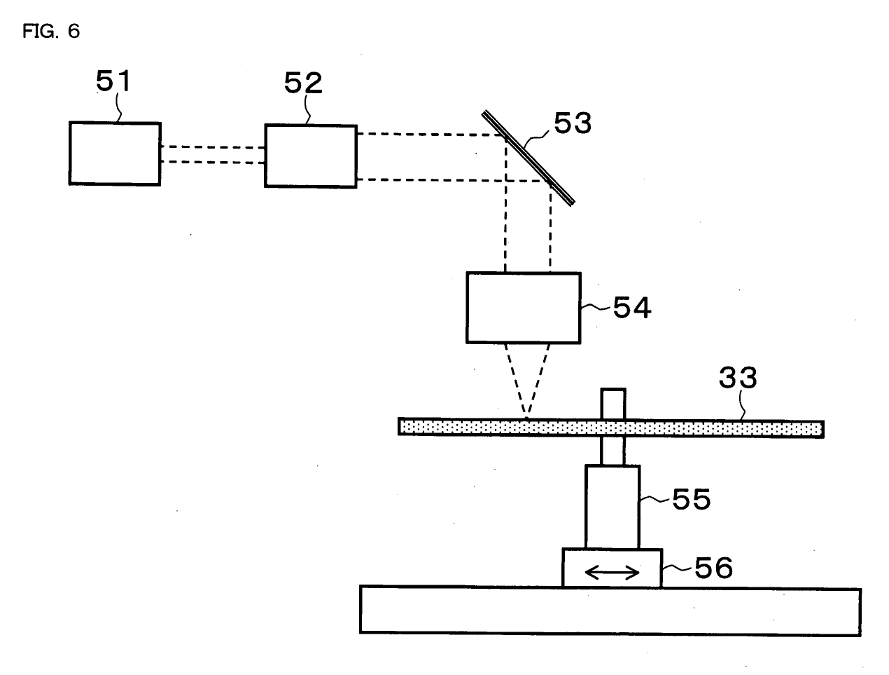

FIG. 6 is a diagram illustrating a method for forming the bump on the recording medium in the information storage apparatus according to the present invention.

Referring to FIG. 6, a laser beam is emitted from a laser oscillator 51, such as a solid-state laser like a YGA laser, a YLF laser, and a YVO4 laser, a carbon dioxide laser, and an argon laser. A laser beam controller 52 controls the light beam emitted from the laser oscillator 51 and a condensing optical unit 54 condenses the laser beam controlled by the laser beam controller 52 and irradiates the recording medium 30 with the condensed light beam. In addition, a reflection mirror 53 is provided in the present embodiment. A rotating mechanism 55 rotates a recording medium substrate 33 at a predetermined rotational speed and a translation mechanism 56 translates the rotating mechanism 55. Instead of translating the rotating mechanism 55, the condensing optical unit 54 may also be translated.

The recording medium substrate 33 is obtained by coating the surface an aluminum substrate or a glass substrate with a Ni—P layer by electroless plating. The recording medium 30, which is the final product, is obtained by successively forming an underlying layer of Cr, a magnetic layer of CoCr or the like, and a protection layer of DLC on the Ni—P layer and applying a lubricant layer of perfluoropolyether.

A method for forming the bump according to the present embodiment will be described below. First, the rotating mechanism 55 is translated by the translation mechanism 56 while the recording medium substrate 33, which is heated to a predetermined temperature in advance, is rotated by the rotating mechanism 55 at a predetermined rotational speed. At the same time, the unused region 32, for example, an outer or inner peripheral region outside the data zone of the recording medium substrate 33 is irradiated with the light beam condensed by the condensing optical unit 54 in a pulse like or continuous manner under the control of the laser beam controller 52. Accordingly, the bump 31 is formed.

Although the bump is formed by the light beam in the present embodiment, the bump may also be formed by pressing or laminating a thin film on the surface of the recording medium.

Next, a calibration method according to a first embodiment of the present invention will be described below.

In the first embodiment, the information storage apparatus according to the present invention is applied to a mobile apparatus.

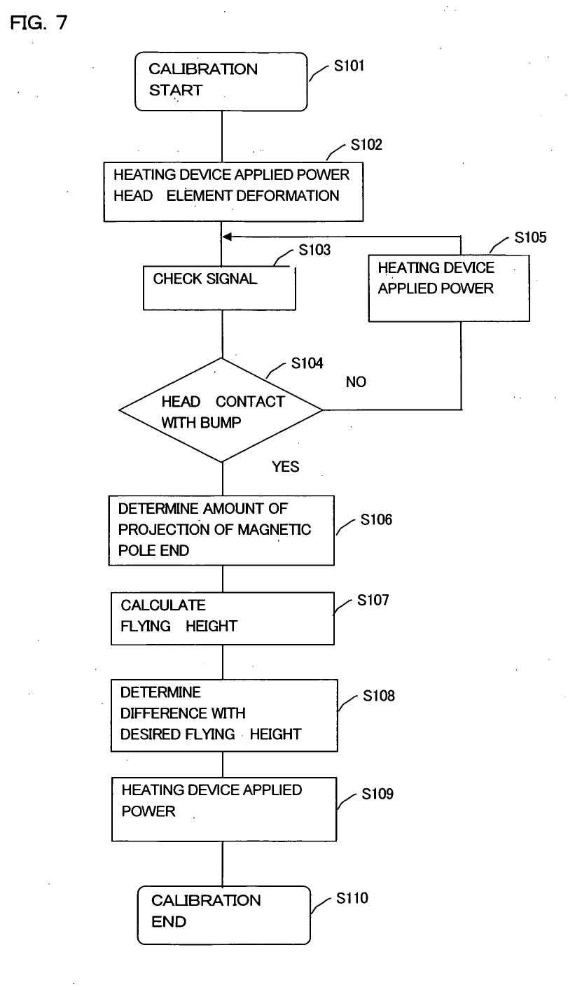

FIG. 7 is a flowchart illustrating a process for calibrating the magnetic head flying height according to the present embodiment.

First, when the power of the information storage apparatus is turned on, a command for starting the calibration of the magnetic head 21 is executed (S101). Then, electric power is applied to the heating device 19 to heat the thin-film magnetic head element 10 so that the magnetic pole end 40 of the recording and reproducing elements 41 and 42 is deformed so as to project (S102). Then, the flying-height adjustment controller in the CPU checks a signal transmitted from the magnetic head 21 (S103), and it is determined whether or not the projection of the magnetic pole end 40 is in contact with the bump 31 formed on the recording medium on the basis of the signal (S104). The signal transmitted from the magnetic head 21 may be checked by the following methods. That is, for example, an output signal obtained form the acoustic emission sensor 23 when the magnetic head 21 comes into contact with the bump 31 and contact vibration is generated may be checked. Alternatively, test data may be recorded in a region of the recording medium where the bump 31 is formed, and an output signal obtained by the magnetic field generated by the test data may be checked.

If it is determined that the projection of the magnetic pole end 40 is not yet in contact with the bump 31 formed on the recording medium, the electric power is further applied to the heating device 19 to increase the amount of projection of the magnetic pole end 40 (S105). This step is repeated until it is determined that the projection of the magnetic pole end 40 has come into contact with the bump 31 formed on the recording medium.

If it is determined that the projection of the magnetic pole end 40 is in contact with the bump 31 formed on the recording medium, the projection measurement unit in the CPU determines the amount of projection of the magnetic pole end 40 on the basis of the electric power applied to the heating device 19 (S106). The memory unit 29 stores data representing the relationship between the amount of projection of the magnetic pole end 40 and the electric power applied to the heating device 19 in advance. Accordingly, the amount of projection of the magnetic pole end 40 is determined from the electric power applied to the heating device 19 when the projection of the magnetic pole end 40 comes into contact with the bump 31 formed on the recording medium. Then, the flying height of the magnetic head relative to the apex of the bump 31 is calculated on the basis of the determined amount of projection (S107). Next, the sum of the thus calculated flying height and the height of the bump 31 is compared with the desired flying height, and a difference between them is determined (S108). Then, the electric power is applied to the heating device 19 such that the magnetic pole end 40 projects by the amount corresponding to the determined difference (S109). When the projection of the magnetic pole end 40 is completed, the calibration is finished (S110).

According to the above-described process, the accurate flying height of the magnetic head can be obtained and the electric power to be applied to the heating device to set the flying height of the magnetic head to the desired flying height can be accurately determined. Accordingly, the number of times the magnetic pole end is caused to project during calibration can be reduced and the flying height of the magnetic head can be quickly set to the desired flying height. Thus, the time required for calibration can be reduced. Therefore, the magnetic head can be adjusted to an optimum flying height in a relatively short time, and a power saving information storage apparatus that can be activated in a short time can be provided.

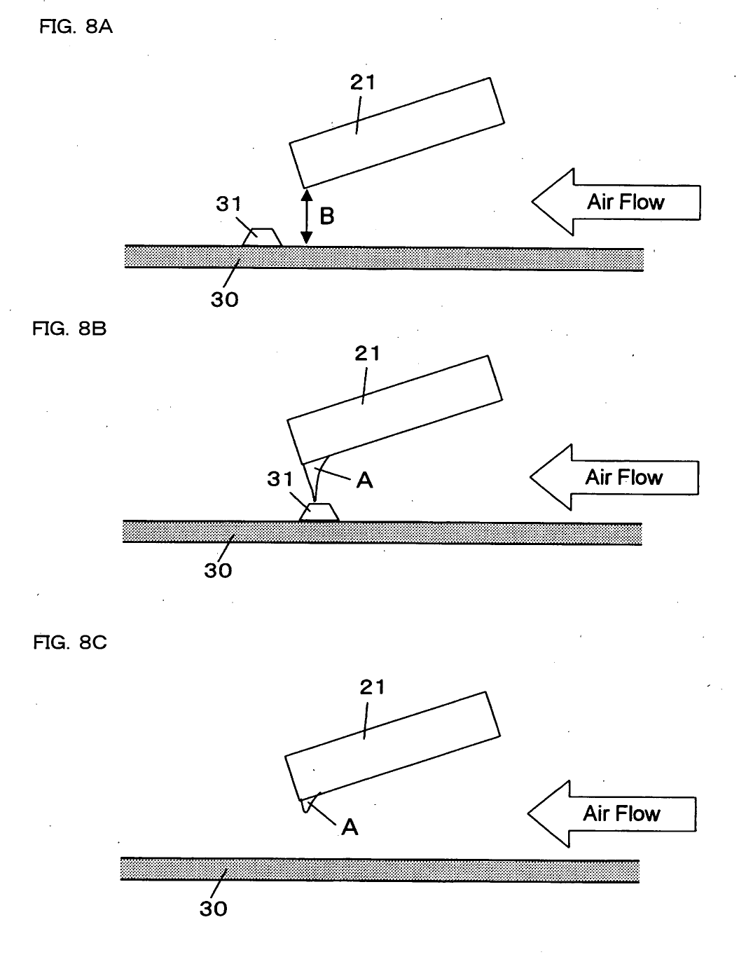

FIGS. 8A to 8C are diagrams illustrating the steps of the process for calibrating the magnetic head flying height according to the present invention.

FIG. 8A shows the state in which the flying height of the magnetic head is not yet calibrated. The flying height of the magnetic head is shown by B in FIG. 8A, and the flying height differs depending on the operating environment of the information storage apparatus, component accuracy, and assembly accuracy. FIG. 8B shows the state in which the flying height of the magnetic head is being calibrated. As shown by A, the magnetic pole end of the magnetic head is caused to project until the magnetic pole end comes into contact with the bump 31, and the amount of projection of the magnetic head is determined from the electric power consumed. Then, the flying height of the magnetic head is determined. FIG. 8C shows the state after the flying height of the magnetic head is calibrated. The electric power required for setting the gap between the projection of the magnetic pole end and the surface of the recording medium 30 to the desired flying height is calculated, and the thus calculated electric power is applied to the heating device. Accordingly, the amount of projection of the magnetic pole end is controlled as shown by A in the figure.

Next, a calibration method according to a second embodiment of the present invention will be described below.

In the second embodiment, the information storage apparatus according to the present invention is applied to a non-mobile apparatus.

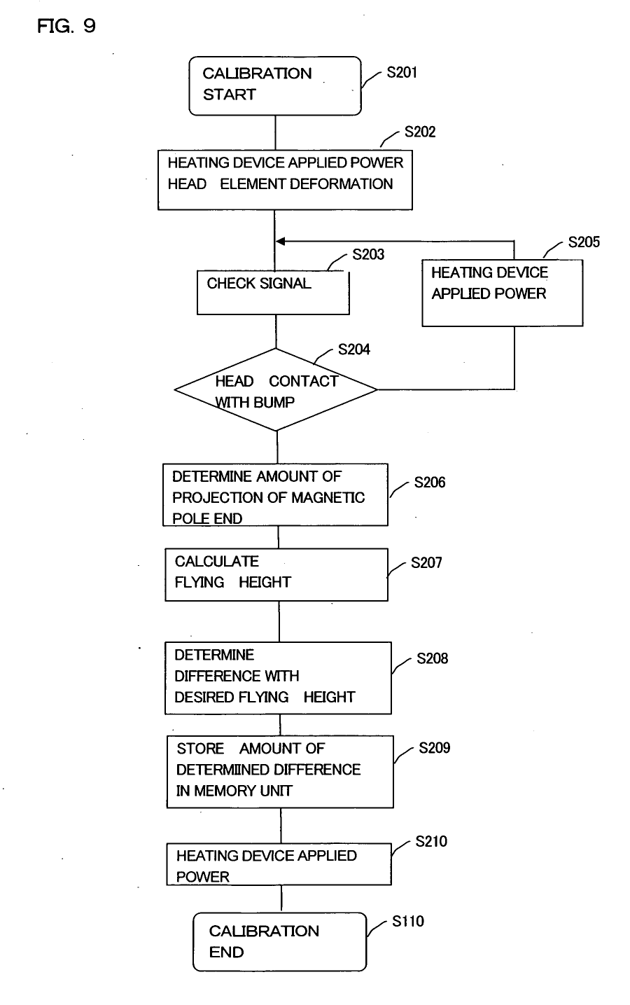

FIG. 9 is a flowchart illustrating a process for calibrating the magnetic head flying height according to the present embodiment.

First, before the information storage apparatus is shipped, a command for starting the calibration of the magnetic head 21 is executed (S201). Then, electric power is applied to the heating device 19 to heat the thin-film magnetic head element 10 so that the magnetic pole end 40 of the recording and reproducing elements 41 and 42 is deformed so as to project (S202). Then, the flying-height adjustment controller in the CPU checks a signal transmitted from the magnetic head 21 (S203), and it is determined whether or not the projection of the magnetic pole end 40 is in contact with the bump 31 formed on the recording medium on the basis of the signal (S204). The signal transmitted from the magnetic head 21 may be checked by the following methods. That is, for example, an output signal obtained form the acoustic emission sensor 23 when the magnetic head 21 comes into contact with the bump 31 and contact vibration is generated may be checked. Alternatively, test data may be recorded in a region of the recording medium where the bump 31 is formed, and an output signal obtained by the magnetic field generated by the test data may be checked.

If it is determined that the projection of the magnetic pole end 40 is not yet in contact with the bump 31 formed on the recording medium, the electric power is further applied to the heating device 19 to increase the amount of projection of the magnetic pole end 40 (S205). This step is repeated until it is determined that the projection of the magnetic pole end 40 has come into contact with the bump 31 formed on the recording medium.

If it is determined that the projection of the magnetic pole end 40 is in contact with the bump 31 formed on the recording medium, the projection measurement unit in the CPU determines the amount of projection of the magnetic pole end 40 on the basis of the electric power applied to the heating device 19 (S206). The memory unit 29 stores data representing the relationship between the amount of projection of the magnetic pole end 40 and the electric power applied to the heating device 19 in advance. Accordingly, the amount of projection of the magnetic pole end 40 is determined from the electric power applied to the heating device 19 when the projection of the magnetic pole end 40 comes into contact with the bump 31 formed on the recording medium. Then, the flying height of the magnetic head relative to the apex of the bump 31 is calculated on the basis of the determined amount of projection (S207). Next, the sum of the thus calculated flying height and the height of the bump 31 is compared with the desired flying height, and a difference between them is determined (S208). Then, the electric power required for causing the magnetic pole end 40 to project by the amount corresponding to the determined difference is calculated and stored in the memory unit 29 (S209). Then, the thus calculated electric power is applied to the heating device 19 (S210). When the projection of the magnetic pole end 40 is completed, the calibration is finished (S211).

In the heating device according to the present embodiment, the calibration is performed before the information storage apparatus is shipped. However, even when the information storage apparatus according to the present invention is applied to a non-mobile apparatus, the calibration may be performed each time the power of the information storage apparatus is turned on, similar to the first embodiment.

According to the above-described process, the calibration of the flying height of the magnetic head is performed before the product is shipped and the electric power corresponding to the optimum flying height of the magnetic head is stored in the memory unit in advance. When data is recorded or reproduced, the electric power is read out for the calibration. Accordingly, the flying height of the magnetic head can be quickly set to the desired flying height, and the time required for calibration can be reduced. Therefore, the magnetic head can be adjusted to an optimum flying height in a relatively short time, and a power saving information storage apparatus that can be activated in a short time can be provided.

The present invention in not limited to the above-described embodiments and drawings, and various modifications are possible within the scope of the present invention.

What is claimed is:

1. An information storage apparatus comprising:
a magnetic head having a magnetic pole end controllable so as to project;
a recording medium for recording and/or reproducing data;
a protrusion provided on a surface of the recording medium, the protrusion being used for measuring a flying height of the magnetic head; and
a flying-height adjustment controller for adjusting the flying height of the magnetic head by controlling the amount of projection of the magnetic pole end of the magnetic head on the basis of the amount of projection obtained upon the magnetic pole end of the magnetic head coming into contact with the protrusion.

2. The information storage apparatus according to claim 1, wherein the protrusion is formed in a region that is not used for recording and/or reproducing the data.

3. The information storage apparatus according to claim 1, wherein the protrusion is formed by irradiating the recoding medium with a laser beam.

4. The information storage apparatus according to claim 1, wherein the magnetic head includes:
a heating device that generates heat when electric power is applied; and
a heating-device controller that controls the heating device and causes the magnetic pole end of the magnetic head to project.

5. The information storage apparatus according to claim 4, wherein the flying-height adjustment controller includes a projection measurement unit that determines the amount of projection of the magnetic pole end of the magnetic head on the basis of the electric power applied to the heating device.

6. The information storage apparatus according to claim 5, wherein the flying-height adjustment controller determines the difference between a desired flying height and the sum of the amount of projection determined by the projection measurement unit when the magnetic pole end of the magnetic head comes into contact with the protrusion and the height of the protrusion and calculates the electric power required for causing the magnetic pole end to project by the amount corresponding to the determined difference.

7. The information storage apparatus according to claim 6, wherein the flying-height adjustment controller adjusts the flying height of the magnetic head when the power of the device is turned on.

8. A method for adjusting a flying height of a magnetic head in an information storage apparatus including the magnetic head that has a magnetic pole end and a heating device, a recording medium for recording and/or reproducing data, and a protrusion provided on a surface of the recording medium, the method comprising:
a projecting step of causing the magnetic pole end of the magnetic head to project by heat generated by the heating device;
a projection measuring step of measuring the amount of projection of the magnetic head on the basis of electric power applied to the heating device; and
a flying-height calculating step of calculating the flying height of the magnetic head by adding the amount of projection obtained upon the magnetic pole end of the magnetic head coming into contact with the protrusion and the height of the protrusion,
wherein the flying height of the magnetic head is adjusted by controlling the amount of projection of the magnetic pole end of the magnetic head on the basis of the difference between a desired flying height and the flying height of the magnetic head calculated in the flying-height calculating step.
